(19) United States
(12) Patent Application Publication
(10) Pub. No.: US 2023/0401655 A1
(43) Pub. Date: Dec. 14, 2023

(54) SYSTEM AND METHOD USING BLOCKCHAIN TO INCENTIVIZE WATER CONSERVATION

(71) Applicants: John Armstrong, Las Vegas, NV (US); Ofer Tenenbaum, Napa, CA (US); George Stuart Richmond, Fairfield, CA (US); Daniel Honeywell, Kelseyville, CA (US)

(72) Inventors: John Armstrong, Las Vegas, NV (US); Ofer Tenenbaum, Napa, CA (US); George Stuart Richmond, Fairfield, CA (US); Daniel Honeywell, Kelseyville, CA (US)

(21) Appl. No.: 18/207,584

(22) Filed: Jun. 8, 2023

Related U.S. Application Data
(60) Provisional application No. 63/350,834, filed on Jun. 9, 2022.

(51) Int. Cl. G06Q 50/06; G06Q 20/38; G06Q 20/36

(52) U.S. Cl. CPC G06Q 50/06; G06Q 20/389; G06Q 20/367

(57) ABSTRACT

A water conservation incentivization system including a water source, a water extraction system, a sensor coupled to the water extraction system to collect water extraction data during a water extraction transaction, a server carrying water extraction criteria, and a reporting device wirelessly coupled between the sensor and the server for uploading collected water extraction data of the water extraction transaction to the server. The water extraction criteria carried by the server and the water extraction data for the water extraction transaction determine associated token allotment. A blockchain network is coupled to the server for receiving and logging the collected water extraction data of the water extraction transaction with associated tokens to a blockchain, the tokens added or subtracted as determined by the server using the water extraction criteria.

### CROSS-REFERENCE TO RELATED APPLICATION

This application claims the benefit of U.S. Provisional Application No. 63/350,834, filed 9 Jun. 2022.

### FILED OF THE INVENTION

This invention relates to water use management. More particularly, the present invention relates to incentivizing water conservation in a water extraction system.

### BACKGROUND OF THE INVENTION

The supply of fresh water, either from groundwater, surface water, or municipal sources is becoming stressed in many areas due to increasing populations, agriculture, and industrial use. Sometimes new sources are developed, new reservoirs or catch basins and the like. However, there is a limit to how much water can be provided. Many drought-struck areas or just areas of heavy water use are requiring conservation efforts and have established rules and regulations to try to limit water use. While somewhat successful, these attempts often fall short of the desired level of conservation and often aggravate and annoy water users. Often, water users feel this forced conservation is very onerous with no observable reward or effect. Also, current water rights and regulations often unintentionally incentivize users to pump as much water as possible and their usage is not tracked or valued.

One result of increased water use is to develop more wells to tap into aquifers and/or pump water from the aquifer at greater rates. Fresh and potable groundwater, while renewable, is limited. The only natural source of water on land is precipitation. Precipitation can eventually become groundwater. Because of a slow rate of travel, limited recharge areas, evaporation from surfaces, faster runoff from overland due to land cover/land use changes, and intensifying extraction and demand in many places, groundwater can be extracted faster than it is replenished. When groundwater is extracted faster than recharge can replace it, groundwater levels decline and areas of discharge can diminish or dry up completely. This over-extraction of groundwater can lead to dry wells, reduced spring and streamflow, increase groundwater pollution from deeper waters, land subsidence, and other damages to an aquifer. When additional sources of water are unavailable, reduction in water usage is the only option.

It would be highly advantageous, therefore, to remedy the foregoing and other deficiencies inherent in the prior art.

An object of the present invention is to provide a method and system for incentivizing water conservation.

### SUMMARY OF THE INVENTION

Briefly to achieve the desired objects and advantages of the instant invention in accordance with a preferred embodiment provided is a water conservation incentivization system. Water conservation incentivization system includes a water source, a water extraction system having a distribution channel supplying water from the water source to an end use element, a sensing and monitory system and a blockchain network. The sensing and monitory system includes a sensor coupled to the water extraction system distribution channel to collect water extraction data during a water extraction transaction, a server carrying water extraction criteria, and a reporting device, such as a mote, wirelessly coupled, using a communication protocol, between the sensor and the server for uploading collected water extraction data of the water extraction transaction to the server. The water extraction criteria carried by the server and the water extraction data for the water extraction transaction determine the associated token allotment. The blockchain network is coupled to the server for receiving and logging the collected water extraction data of the water extraction transaction with associated tokens to a blockchain, the tokens added or subtracted as determined by the server using the water extraction criteria.

Also provided, is a method of incentivizing water conservation. The method includes the steps of providing a water source, extracting water from the water source in a water extraction transaction, using a sensor to collect water extraction data for the water extraction transaction, and uploading water extraction data for the water extraction transaction to a server using a reporting device wirelessly coupled, using a communication protocol, between the sensor and the server. The method also includes providing water extraction criteria carried by the server, using the water extraction criteria and the water extraction data for the water extraction transaction to determine associated token allotment, and logging the collected water extraction data of the water extraction transaction with associated tokens to a blockchain, the tokens added or subtracted to an account as determined by the server using the water extraction criteria and the water extraction data for the water extraction transaction.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a simplified schematic diagram of a water conservation incentivizing system according to the present invention;

FIG. 2 is a simplified schematic diagram of a sensing and monitoring system of the water conservation incentivizing system, according to the present invention;

FIG. 3 is a schematic illustrating the connectivity of a blockchain logging system according to the present invention;

FIG. 4 is a simplified flow chart of water use and associated incentives of the sensing and monitoring system of the water extraction system according to the present invention;

FIG. 5 is a simplified diagram of flow-based water source extraction monitoring; and

FIG. 6 is a simplified diagram of a server device

### DETAILED DESCRIPTION

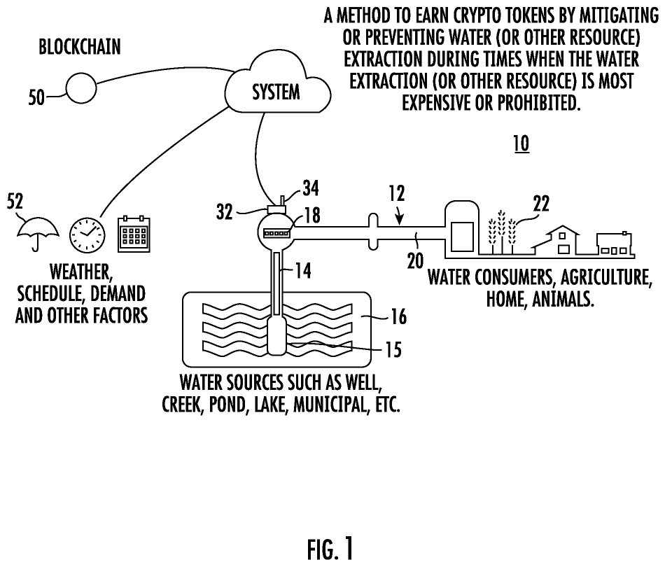

Turning now to the drawings in which like reference characters indicate corresponding elements throughout the several views, attention is directed to FIG. 1 which illustrates a water conservation incentivizing system generally designated 10. Water conservation incentivizing system 10 is employed with one or more water extraction systems 12. Water extraction system 12 in the preferred embodiment includes a standing pipe 14 extending between a pump 15 carried by a water source 16, and a distribution hub 18 (such as a wellhead). Water source 16 can include a well, pond, lake, river, canal, municipal source, and the like. Water extracted from water source 16 passes through distribution hub 18 and through a distribution line to a use element 22. Use element 22 can be a direct use element, such as watering fields, livestock and the like, or use element 22 can be used for collection such as a reservoir or other storage element for later use. Thus, pump 15 pumps water from water source 16 to use element 22 through standing pipe 14 and distribution line 20. While in this embodiment pump 15 moves water into a distribution channel, it will be understood that municipal water sources and the like may provide water under pressure with no discernable pump being present.

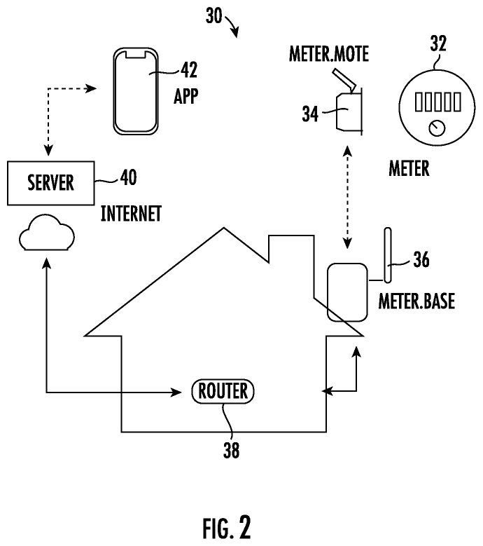

With additional reference to FIG. 2, a sensing and monitory system 30 is illustrated. Sensing and monitory system 30 includes a sensor 32 carried by the distribution channel, such as at distribution hub 18 or distribution line 20, to collect water extraction data during a water extraction transaction. The water extraction data from a transaction includes, when water is being extracted, how much water is being extracted and the rate of water extraction. It will be understood that more than one sensor can be employed for this purpose to provide various data points such as the timeframe of the extraction and the amount extracted either by volume or flow rate, and the like. Sensing and control monitoring system 30 further includes a reporting device, in this preferred embodiment a mote 34, coupled to sensor 32. While other reporting devices can be used, a mote is a small, low-cost, low-power computer which monitors one or more sensors. The mote connects to the outside world with a radio link. In the present invention, mote 34 sends uplinks, with data collected by sensor 32, via LoRaWAN (915 MHz in US) to a gateway 36 that is then internet connected through a router 38, reporting to a server 40 and then to an application 42, which serves as an interface for management of the system and is carried by a communication device, such as a smart phone and the like. LoRa and LoRaWAN together define a low power, wide area (LPWA) networking protocol designed to wirelessly connect battery operated “things” to the internet in regional, national and global networks, and targets key internet of things (IoT) requirements such as bi-directional communication, end-to-end security, mobility and localization services. In the US LoRWAN uses 902-928 Mhz frequency. While the previous is preferred, it is simply one example of a communication protocol. It will be understood that other communication protocols can be used such as traditional IP networks or other long-range low power networks. As another example, TCP/IP protocol can be used. It will also be understood that while a downloadable application 42 can be carried by a device such as a smartphone which receives data from server 40, application 42 can be supplied by server 40 as Software as a Service (SaaS) which allows users to connect to and use cloud-based apps over the Internet. SaaS provides a software solution that is purchased on a pay-as-you-go basis from a cloud service provider. The use of an app is essentially rented such as by a subscription model, and the users connect to it over the Internet, usually with a web browser. It will be understood that the use of the app can also be provided in other ways, such as it may be offered free of charge and the whole financial model will revolve on saving water and minting of tokens. All of the underlying infrastructure, middleware, app software, and app data are located in the service provider's data center.

Referring back to FIG. 1, sensing and monitory system 30 also supplies uploaded data through server 40 to a blockchain network 50 and an information source 52 providing information such as weather, schedule, resource demands and other factors affecting resource usage. A blockchain is a type of shared database that differs from a typical database in the way it stores information. Blockchains store data in blocks linked together via cryptography. Different types of information can be stored on a blockchain, in this case the stored information is water extraction data as a log of a water extraction transaction and tokens representing the value of a unit of water. Decentralized blockchains are immutable, which means that the data entered is irreversible. For water extraction transactions, transactions are permanently recorded and viewable by anyone. As will be described presently, blockchain network 50 acts as a ledger to keep track of blockchain tokens for an account, either adding or subtracting tokens as determined by server 40 following the water extraction criteria described presently. Essentially, when a water transaction for a user is allowed to occur but no water or less water than allowed is extracted, the value of the water that could have been extracted is credited to the user's account as tokens added to the ledger of the blockchain network 50. If a transaction is not allowed, but a user extracts water anyway, the value of the water that was extracted is removed from the user's account as tokens removed from the ledger of the blockchain network 50. Penalties can also be applied for extraction of water at unsanctioned times, amounts or rates.

With additional reference to FIG. 3, a simplified schematic is used illustrating the use of blockchain network 50. Blockchain network 50 is integrated with sensing and monitory system 30 to incentivize reduced water extraction and conservation to ultimately conserve and improve water use management. During water extraction 54, water extraction data is collected by sensor 32 and passed to blockchain network 50 as described previously. The water extraction data is regularly logged to blockchain network 50 so all participants can see a certified record of water extraction. These usage records become the basis for economic incentives (minting of tokens) and penalties around water usage. The log of the water extraction transaction includes the timeframe of the water extraction transaction, the amount of water extracted, such as flow rate or volume, a flag indicating if the extraction was allowed or not (using extraction criteria), and a metadata field with any relevant business rules and their pass/fail status acting as the extraction criteria. An example of a logged record is:

```
“timestamp”: “2022-01-05T14:00:00.000Z”,
“start_timestamp”: “2022-01-05T00:00:00.000Z”,
“end_timestamp”: “2022-01-05T08:00:00.000Z”,
“amount”: 55,
“units”: “GAL”,
“allowed”: false,
“metadata”:
  “rule_type”: “flow_difference”,
  “allowed_flow_amount”: 44,
  “allowed_flow_units”: “GALSECOND”,
  “actual_flow_amount”: 13,
  “actual_flow_units”: “GALSECOND”,
  “allowed”: false
  “rule_type”: “fow_time”,
  allowed_flow_start_timestamp”: “2022-01-05T00:00:00.000Z”,
  “allowed_flow_end_timestamp”: “2022-01-05T23:59:59.000Z”,
  “actual_flow_start_timestamp”: “2022-01-05T00:00:00.000Z”.
  “actual_flow_end_timestamp”: “2022-01-05T08:00:00.000Z”,
  “allowed”: true
```

In this example, a start and stop time is for the water extraction transaction and the amount of 55 gallons of water being extracted is logged. This record is flagged as being false because rules (extraction criteria) were broken. Specifically, metadata is included in the record specifying rules, also referred to as extraction criteria, by which water can be extracted and compared to the actual extraction. In this example, the metadata includes two rule types for comparison. The first is a rule type of “flow difference” and the second is “flow time”. In this example, the first rule allows 44 gallons per second of water to be extracted. The actual data for extraction is 13 gallons per second. The second rule specifies when water can be extracted. The log can also capture (5) various demographic information about the connected environment, including attributes such as water source, lat/long of the activity (e.g. a well), any associated hardware or certification IDs (e.g. mote ID), and any available licenses and their dates of eligibility.

Extraction criteria can be tailored to the specific situation, environment and conditions of the area from which water is being extracted. This information can be provided by information source 52. Users of a watershed are allowed to extract water based on predetermined allocations. These allocations can take many forms, such as a fixed amount per time period or a flow ratio. The current water rights and regulations unintentionally incentivize users to pump as much water as possible and their usage is not tracked or valued. Water conservation incentivizing system 10 can detect, based on various rules and environmental factors together referred to as extraction criteria, when water extraction would be allowed. If the user is not extracting water during these time periods, the user can be rewarded for their non-use with blockchain tokens issued to represent the water the user did not extract. These blockchain tokens have their own value and use cases and incentivize users to extract only the water they need, not all the water they can since the tokens will have value beyond the extra water. The System can automatically enable or disable extraction during times when it is or is not allowed. The System can also provide mechanisms for a user to override the disablement of extraction using economic incentives.

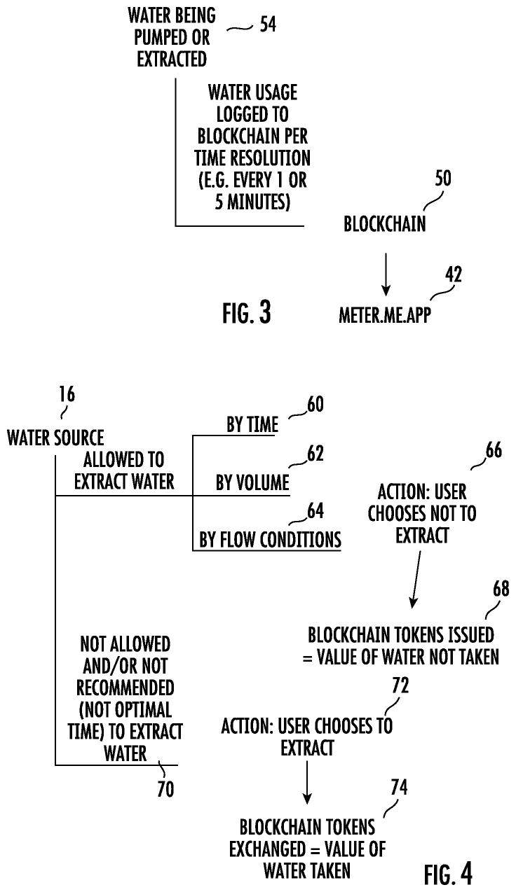

Turning now to FIG. 4, extracting water from water source 16 has two paths according to the present invention. According to rules set as described previously, allowed water extraction can occur by allowed time 60, by volume 62 and/or by flow conditions 64. If a user is allowed to extract according to these conditions, but chooses not to extract 66 blockchain tokens are issued 68 equal to the water not extracted. If the rules do not allow for extraction 70 or if extraction is not optimal or recommended, and the user chooses to extract water 72, blockchain tokens can be surrendered 74 for the value of water extracted.

Various examples of possible conditions and rules includes time/volume base extraction, flow-based extraction, outside of rule extraction, and negative balance extraction. Time/volume based extraction includes situation where a user may have a well and wish to extract water from it. Using regulations and guidelines, the system will set up and/or enforce a schedule of water extraction and the allowed volumes. Whenever the time window is open and the volume limits have not yet been met, the user has a right to extract water and their pump is enabled. For every gallon they do not extract of their allowance, they will be issued a specific number of blockchain tokens to represent the value of the water they did not extract. If the user extracts water outside of their allowed parameters, a specific extraction notice is logged to the blockchain for future reference and workflow, such as fines or payments. In the case of groundwater, the allowed vs. prohibitive extraction can be mandated by the water table height. For example, if a user extracts water at a slow rate so not to exceed the recharge rate, the system will deposit water tokens corresponding to the lower/slower extraction. However, if the user extracts water when the water table is too low and/or even to the point the well recharge is exhausted, the user will be penalized.

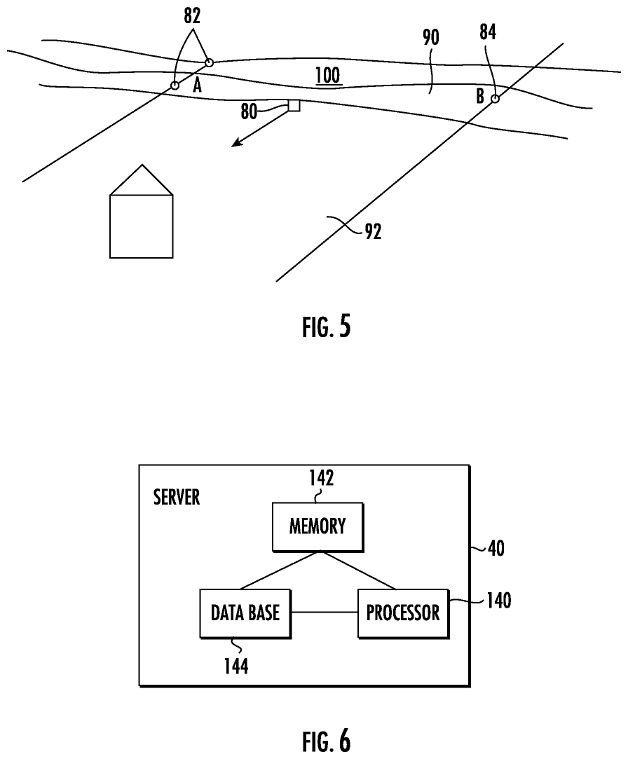

With reference to FIG. 5, in flow-based extraction, a user is allowed to extract water within certain flow conditions. In this case, there is an extraction device 80, such as a pump, situated between two measurement devices 82 and 84. When the differential in flow between the measurement devices 82 and 84 is within defined bounds, and other business rules are met, extraction device 80 is enabled for water extraction automatically. The user can now extract water in compliance with regulations. For every gallon of water they do not extract during this time period, they will be issued a specific number of blockchain tokens to represent the value of the water they did not extract. If the user extracts water outside of their allowed parameters, a specific extraction notice is logged to the blockchain for future reference and workflow, such as fines or payments. In an example of flow-based extraction, a creek 90 crosses from one side of a property 92 (Point A) to the other side of property 92 (Point B). The owner is permitted by government regulations or water rights to take water from the creek to their home when the flow at A is x and the flow at B is y and the delta between x and y is <z. Measurement devices 82 and 84 are, for example placed at points A and B to collect the data and uploaded as part of sensing and monitory system 30. If the owner is allowed to take water when the flow is less than z and does not, they are incentivized by the issue of blockchain tokens to represent the water they did not take. Conversely, if the owner is not allowed to take water and does they will pay in blockchain tokens until they run out or the system turns their water off.

Another example is a user that wishes to extract water when they are not allowed to or outside of rule extraction. Using the system, they could exchange blockchain tokens for the right to extract water. The system would accept these tokens and enable a specific amount of extraction, regardless of their current extraction enablement status. Users can earn these blockchain tokens using the system incentives schemes, or they can purchase them for market value on an exchange. To accommodate a situation whereby the user has no water tokens but is in need of water, the system could generate and record a negative balance. This means that even when the user returns to sustainable extraction, or lack of allowed extraction, they would first have to build back their balance to zero before they can accumulate water tokens.

One of ordinary skill in the art will understand that the rate of minting or issue of blockchain tokens can be adjusted due to the prevailing conditions. In extreme conditions, which may vary but could be established as drought times and the like, tokens may be more rapidly minted for enhanced conservation. Peak hours times of water extraction may have regular minting of tokens. Normal times of water extraction may mint tokens only if desired as use or not doesn't particularly affect water conservation. Abundance time, when water is present in abundance may mint no tokens as there is no need to conserve.

All of these System activities leave a permanent record on the Blockchain that can be transparently reviewed and acted upon by 3rd parties and other software systems including application 42. Examples of these workflows include: Automatic bill creation, automatic payment using blockchain tokens, issuance of fines or rewards, and comprehensive aquifer oversight by 3rd parties without going through a commercial entity (because they are available to view on the blockchain). While the resource described herein is water, it will be understood that this system can be employed with other resources. Specifically, these can include other telemetry systems used in agricultural, ranch, farm, and rural living applications, such as sensors collecting data from components that measure or monitor digital or analog inputs and outputs such as water and liquid levels, pressure, current or voltage. Also, while the unit of measure in the examples is gallons, it will be understood that other units of measure can be employed such as liters, acre or any other agreed upon unit of water, including absolute value or value of water per period of time.

Referring now to FIG. 6, server 40, which provides the computations for determining token allocation includes a processor 140, an application stored in a memory 142, and a database 144 for storing collected data. Memory 142 is a non-transitory computer-readable storage medium having instructions (the application) which, responsive to being executed by processor 140, generates the token allocation dependent on the water extraction data and the water extraction criteria. The non-transitory computer-readable storage medium can take on a variety of forms. For instance, the medium may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, the computer-readable storage medium is non-transitory, is not a signal, is not a transient signal, and is not a propagating signal. The medium described herein is an article of manufacture. One of ordinary skill in the art understands how software application work in a server with a processor and memory for storing data and applications, so further detail is omitted.

The present invention is described above with reference to illustrative embodiments. Those skilled in the art will recognize that changes and modifications may be made in the described embodiments without departing from the nature and scope of the present invention. Various changes and modifications to the embodiments herein chosen for purposes of illustration will readily occur to those skilled in the art. To the extent that such modifications and variations do not depart from the spirit of the invention, they are intended to be included within the scope thereof.

1. A water conservation incentivization system comprising:
a water source;
a water extraction system having a distribution channel supplying water from the water source to an end-use element;
a sensing and monitory system including:
a sensor coupled to the water extraction system distribution channel to collect water extraction data during a water extraction transaction;
a server carrying water extraction criteria; and
a reporting device wirelessly coupled, using a communication protocol, between the sensor and the server for uploading collected water extraction data of the water extraction transaction to the server;
wherein the water extraction criteria carried by the server and the water extraction data for the water extraction transaction determine associated token allotment; and
a blockchain network coupled to the server for receiving and logging the collected water extraction data of the water extraction transaction with associated tokens to a blockchain, the tokens added or subtracted as determined by the server using the water extraction criteria.

2. The water conservation incentivization system as claimed in claim 1 further including an information source coupled to the server to provide information affecting resource usage to the server to update water extraction criteria.

3. The water conservation incentivization system as claimed in claim 1 wherein the water extraction data for water extraction transactions include when water is being extracted, how much water is being extracted and the rate of water extraction.

4. The water conservation incentivization system as claimed in claim 1 further including a communication device coupled to the server and an application carried by one of the server and the communication device employing the water extraction criteria and the water extraction data from the water extraction transaction to calculate associated tokens logged to the blockchain network as a blockchain.

5. The water conservation incentivization system as claimed in claim 4 wherein the associated tokens are added to when the water extraction criteria are met and subtracted from when the water extraction criteria are not met.

6. A method of incentivizing water conservation comprising the steps of:
providing a water source;
extracting water from the water source in a water extraction transaction;
using a sensor to collect water extraction data for the water extraction transaction;
uploading water extraction data for the water extraction transaction to a server using a reporting device wirelessly coupled, using a communication protocol, between the sensor and the server;
providing water extraction criteria carried by the server;
using the water extraction criteria and the water extraction data for the water extraction transaction to determine associated token allotment; and
logging the collected water extraction data of the water extraction transaction with associated tokens to a blockchain, the tokens added or subtracted to an account as determined by the server using the water extraction criteria and the water extraction data for the water extraction transaction.

7. The method of incentivizing water conservation as claimed in claim 6 wherein the step of using the water extraction criteria and the water extraction data for the water extraction transaction to determine associated token allotment further comprising the steps of:
determining if the water extraction transaction is allowed to occur but no water or less water than allowed is extracted, then the value of the water that could have been extracted is credited to the account as tokens added to the account of the blockchain; and
determining if the water extraction transaction is not allowed to occur but water is extracted anyway, then the value of the water that was extracted is removed from the account as tokens removed from the account of the blockchain.

8. The method of incentivizing water conservation as claimed in claim 6 wherein the water extraction data includes when water is being extracted, how much water is being extracted and the rate of water extraction.

9. The method of incentivizing water conservation as claimed in claim 6 wherein the step of providing water extraction criteria carried by the server includes updating the water extraction criteria with information affecting resource usage provided by an information source coupled to the server.

10. The method of incentivizing water conservation as claimed in claim 6 wherein the step of providing water extraction criteria carried by the server includes adjusting the rate of issue of blockchain tokens according to prevailing conditions.
